(19) United States
(12) Patent Application Publication
(10) Pub. No.: US 2009/0085652 A1
(43) Pub. Date: Apr. 2, 2009

(54) COMPENSATION OF OPERATING TIME RELATED DEGRADATION OF OPERATING SPEED BY ADAPTING THE SUPPLY VOLTAGE

(76) Inventors: Maciej Wiatr, Dresden (DE); Karsten Wieczorek, Dresden (DE); Casey Scott, Dresden (DE)

Correspondence Address: WILLIAMS, MORGAN & AMERSON, 10333 RICHMOND, SUITE 1100, HOUSTON, TX, 77042, US

(21) Appl. No.: 12/061,079

(22) Filed: Apr. 2, 2008

(30) Foreign Application Priority Data
Sep. 29, 2007 (DE) 10 2007 046 844.1

(51) Int. Cl. G05F 1/10

(52) U.S. Cl. 327/540

(57) ABSTRACT

By controlled increase of the supply voltage of sophisticated integrated circuits, the performance degradation over a lifetime may be significantly reduced. For this purpose, the upper limits of the supply voltage and the thermal design power are taken into consideration when increasing the supply voltage, which may then compensate for a typical performance degradation resulting in a more stable overall performance of integrated circuits. Thus, greatly reduced guard bands for parts classification may be used compared to conventional strategies.

### BACKGROUND OF THE INVENTION

1. Field of the Invention

Generally, the present disclosure relates to highly sophisticated integrated circuits, such as CPUs, including highly scaled transistor elements and compensation techniques for enhancing product performance.

2. Description of the Related Art

The fabrication of advanced integrated circuits, such as CPUs, storage devices, ASICs (application specific integrated circuits) and the like, requires the formation of a large number of circuit elements on a given chip area according to a specified circuit layout, wherein field effect transistors represent one important type of circuit elements that substantially determine performance of the integrated circuits. Generally, a plurality of process technologies are currently practiced, wherein, for many types of complex circuitry, including field effect transistors, MOS technology is currently one of the most promising approaches due to the superior characteristics in view of operating speed and/or power consumption and/or cost efficiency. During the fabrication of complex integrated circuits using, for instance, MOS technology, millions of transistors, e.g., N-channel transistors and/or P-channel transistors, are formed on a substrate including a crystalline semiconductor layer. A field effect transistor, irrespective of whether an N-channel transistor or a P-channel transistor is considered, typically comprises so-called PN junctions that are formed by an interface of highly doped regions, referred to as drain and source regions, with a slightly doped or non-doped region, such as a channel region, disposed adjacent to the highly doped regions.

In a field effect transistor, the conductivity of the channel region, i.e., the drive current capability of the conductive channel, is controlled by a gate electrode formed adjacent to the channel region and separated therefrom by a thin insulating layer. The conductivity of the channel region, upon formation of a conductive channel due to the application of an appropriate control voltage to the gate electrode, depends on the dopant concentration, the mobility of the charge carriers and, for a given extension of the channel region in the transistor width direction, on the distance between the source and drain regions, which is also referred to as channel length. Hence, in combination with the capability of rapidly creating a conductive channel below the insulating layer upon application of the control voltage to the gate electrode, the conductivity of the channel region substantially affects the performance of MOS transistors. Thus, as the speed of creating the channel, which depends on the conductivity of the gate electrode, and the channel resistivity substantially determine the transistor characteristics, the scaling of the channel length, and associated therewith the reduction of channel resistivity and increase of gate resistivity, is a dominant design criterion for accomplishing an increase in the operating speed of the integrated circuits.

Presently, the vast majority of integrated circuits are based on silicon due to substantially unlimited availability, the well-understood characteristics of silicon and related materials and processes and the experience gathered during the last 50 years. Therefore, silicon will likely remain the material of choice for future circuit generations designed for mass products. One reason for the dominant importance of silicon in fabricating semiconductor devices has been the superior characteristics of a silicon/silicon dioxide interface that allows reliable electrical insulation of different regions from each other. The silicon/silicon dioxide interface is stable at high temperatures and, thus, allows the performance of subsequent high temperature processes, as are required, for example, for anneal cycles to activate dopants and to cure crystal damage, without sacrificing the electrical characteristics of the interface.

For the reasons pointed out above, in field effect transistors, silicon dioxide is preferably used as a gate insulation layer that separates the gate electrode, frequently comprised of polysilicon or other metal-containing materials, from the silicon channel region. In steadily improving device performance of field effect transistors, the length of the channel region has continuously been decreased to improve switching speed and drive current capability. Since the transistor performance is controlled by the voltage supplied to the gate electrode to invert the surface of the channel region to a sufficiently high charge density for providing the desired drive current for a given supply voltage, a certain degree of capacitive coupling, provided by the capacitor formed by the gate electrode, the channel region and the silicon dioxide disposed therebetween, has to be maintained. It turns out that decreasing the channel length requires an increased capacitive coupling to avoid the so-called short channel behavior during transistor operation. The short channel behavior may lead to an increased leakage current and to a dependence of the threshold voltage on the channel length. Aggressively scaled transistor devices with a relatively low supply voltage, and thus reduced threshold voltage, may suffer from an exponential increase of the leakage current while also requiring enhanced capacitive coupling of the gate electrode to the channel region. Thus, the thickness of the silicon dioxide layer has to be correspondingly decreased to provide the required capacitance between the gate and the channel region. For example, a channel length of approximately 0.08 μm may require a gate dielectric made of silicon dioxide as thin as approximately 1.2 nm. Although, generally, high speed transistor elements having an extremely short channel may preferably be used for high speed applications, whereas transistor elements with a longer channel may be used for less critical applications, such as storage transistor elements, the relatively high leakage current caused by direct tunneling of charge carriers through an ultra-thin silicon dioxide gate insulation layer may reach values for an oxide thickness in the range or 1-2 nm that may represent limitations for performance driven circuits. That is, product reliability and lifetime are strongly correlated with short channel effects, i.e., impact ionization and hot carrier injection (HCI) in combination with gate dielectric leakage.

Consequently, significant efforts are made in improving manufacturing technologies in an attempt to reduce the speed variation in device characteristics to achieve a high yield of products meeting predetermined specifications in terms of performance, reliability and lifetime. For example, any improvements with respect to power consumption, which may be associated with the introduction of new technologies, may translate into improved performance only if the power envelope, that is, the area defined by the allowable maximum supply voltage and the maximum thermal power, remains substantially unchanged. Similarly, further device scaling may be correlated with increased operating speed of the product under consideration, while nevertheless increased power consumption may exceed the allowable design power, thereby not enabling taking significant advantage of the reduced dimensions of the components. Hence, also in this case, a product manufactured by highly sophisticated technologies may still have to be considered as a product of the same specification category irrespective of the advanced manufacturing technologies, which may possibly come along with increased production costs. Furthermore, in aggressively scaled semiconductor technology, despite any measures taken to guarantee lifetime and reliability of these products, a generally increased degradation of product performance over operating time may be observed, which may have to be taken into consideration when grouping the various products into specific categories, since the respective product has to meet the specifications over the entire lifetime of the product. For example, in advanced microprocessors, this kind of performance degradation manifests itself in a strong degradation of the maximum operating frequency with increasing operating time.

In order to ensure the desired product performance over the entire product lifetime, for instance ten years for microprocessor products, appropriately selected specifications have to be used in which corresponding safety margins or “guard bands” are included to guarantee that a product having characteristics corresponding to a lower limit of the performance specification may nevertheless stay within the specified range during the entire lifetime. This means that, for instance, microprocessors having a specific initial maximum operating frequency may have to be considered as products of lower speed grade, since the degradation in performance over the entire lifetime may finally result in a reduced maximum operating speed that would no longer be within a category corresponding to a higher speed grade.

FIG. 1a schematically illustrates the temporal progression of product performance, for instance, in the form of the maximum operating frequency Fmax of microprocessor products, over the lifetime, such as 10 years, wherein an initial state of the product, indicated as I, may correspond to a certain maximum operating frequency, which decreases or degrades over time so as to arrive at a significantly lower state F representing the performance at the guaranteed lifetime of the product. It should be appreciated that the curve connecting the states I and F is a simplified presentation which, however, qualitatively illustrates the performance degradation of sophisticated integrated circuits.

FIG. 1b schematically illustrates a power envelope representation in which the thermal design power of an integrated circuit is plotted against a performance parameter, such as the maximum operating frequency Fmax of microprocessors, wherein an upper limit for the thermal design power is indicated by TPL. Furthermore, an area A is illustrated in which products are included having a certain maximum operating speed or frequency as determined after fabrication of the devices while also respecting the upper limit TPL of the thermal design power. Furthermore, for the area A, a lower frequency limit is determined that indicates the lowest allowable Fmax so as to specify an actual product speed, indicated as “Product Speed” for a product segment A. That is, the product speed represents the required performance of the product in actual applications, which is, however, significantly lower than the lower “Fmax” limit of the area A due to the time-dependent performance degradation. However, as explained above with reference to FIG. 1a, the product degradation over time may conventionally be taken into consideration by a corresponding “performance guard band.” For example, a product having the maximum operating frequency I after fabrication may have the status F after the lifetime, wherein the state F has to be above the product speed, thereby requiring a moderately wide guard band. Consequently, any products having an initial maximum frequency which is located within the guard band may have to be grouped into a lower product speed segment, thereby reducing the profitability of the entire manufacturing process, as high speed products may typically be sold at higher prices.

As a consequence, reducing the guard band as much as possible may be highly desirable in view of increasing the profitability of the corresponding manufacturing process. In order to increase the number of parts fulfilling high performance requirements, an improvement in technology, for instance the advance to a next technology generation or an improvement in overall product design, may be required but may be associated with significant process modifications resulting in increased research and engineering efforts, thereby contributing to increased production costs.

The present disclosure is directed to various methods and devices that may avoid, or at least reduce, the effects of one or more of the problems identified above.

### SUMMARY OF THE INVENTION

Generally, the subject matter disclosed herein relates to sophisticated integrated circuits and methods for operating the same, wherein a performance degradation over lifetime may be significantly reduced by a compensation technique based on an increased supply voltage of the product under consideration. The constraints determining product requirements for a given product category are typically related to reliability, power consumption and operating speed or performance, for instance in the form of the maximum operating frequency of microprocessor products. The reliability of sophisticated integrated circuits including advanced field effect transistors is strongly related to the lifetime of the gate insulation layer, which is typically provided in the form of a gate oxide layer or other sophisticated dielectric materials, as previously explained, so that the lifetime of the gate insulating layer and the leakage behavior thereof may substantially determine the reliability, for instance, in combination with a respective lifetime of the metallization level that is determined by the electromigration behavior of the metallization layers. Lifetime and leakage of the gate insulating layers are substantially determined by the supply voltage (VDD) used for operating the product for the given technology. Thus, there is an upper limit for the supply voltage which must not be exceeded to guarantee product operation during the entire lifetime. On the other hand, the supply voltage may be used as an efficient parameter for controlling the performance of the product under consideration, thereby providing the possibility of compensation, at least to a significant degree, for the “natural” performance degradation by appropriately increasing the supply voltage under consideration according to the present status of the product with respect to its natural aging while nevertheless maintaining the supply voltage below the critical upper limit.

One illustrative method disclosed herein relates to stabilizing the performance of an integrated circuit device, wherein the method comprises determining a value of a first parameter indicating an accumulated operating time of the integrated circuit device. The method further comprises controlling the increasing of a supply voltage of the integrated circuit device from a first voltage value to a second voltage value on the basis of the value of the first parameter.

Another illustrative method disclosed herein comprises monitoring a maximum performance parameter value representing a current maximum operating performance of at least a portion of an integrated circuit device at a current nominal supply voltage. The method further comprises determining a thermal power parameter value representing a thermal power generated in the integrated circuit device, wherein the thermal power corresponds to the current maximum operating performance. Moreover, the method comprises increasing the nominal supply voltage for the further operation of the integrated circuit device when an updated maximum performance parameter value corresponding to the increased nominal supply voltage and an updated thermal parameter value corresponding to the increased nominal supply voltage each remain within a respective predetermined allowable range.

One illustrative electronic circuit disclosed herein comprises an integrated circuit to be operated with a nominal supply voltage corresponding to a maximum performance of the integrated circuit. The electronic circuit further comprises a controllable supply voltage source configured to provide the nominal supply voltage for the integrated circuit on the basis of a control signal. Additionally, the electronic circuit comprises a control unit configured to establish the control signal so as to increase the nominal supply voltage with increasing accumulated operating time of the integrated circuit while maintaining the increased nominal supply voltage within a predetermined allowable range.

### BRIEF DESCRIPTION OF THE DRAWINGS

The disclosure may be understood by reference to the following description taken in conjunction with the accompanying drawings, in which like reference numerals identify like elements, and in which:

FIGS. 1a-1b schematically illustrate graphical representations of the performance behavior over time of conventional advanced integrated circuits including CMOS transistors;

FIG. 2a schematically illustrates a distribution for advanced integrated circuits with respect to maximum performance and maximum thermal design power for different supply voltages;

FIG. 2b schematically illustrates the situation described in FIG. 2a for a single product with two different supply voltages, wherein an operating point may be shifted, according to illustrative embodiments;

FIG. 3a schematically illustrates an electronic circuit including an advanced integrated circuit in combination with a control unit for compensating for the “natural” aging of the integrated circuit on the basis of supply voltage increase, according to illustrative embodiments;

FIG. 3b schematically illustrates a comparison between an integrated circuit operated according to conventional techniques and an integrated circuit operated on the basis of a compensation technique disclosed herein, wherein a supply voltage is increased over the lifetime of the device, according to illustrative embodiments;

FIG. 3c schematically illustrates the operational behavior of a conventionally operated integrated circuit and an integrated circuit operated according to the principles disclosed herein, wherein a comparison of a conventionally used guard band with a guard band according to the present disclosure is illustrated;

FIG. 3d schematically illustrates an electronic circuit including an integrated circuit wherein a thermal power is directly determined within the integrated circuit to compensate for the natural aging, according to further illustrative embodiments;

FIG. 3e schematically illustrates an electronic circuit with an integrated circuit comprised of appropriate circuit portions for determining a maximum performance parameter and a related thermal power used for compensating for performance degradation, according to still further illustrative embodiments; and

FIG. 3f schematically illustrates an integrated circuit having incorporated therein a control unit for providing a control signal for adjusting an external voltage source to compensate for performance degradation, according to still other illustrative embodiments.

While the subject matter disclosed herein is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION

Various illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The present subject matter will now be described with reference to the attached figures. Various structures, systems and devices are schematically depicted in the drawings for purposes of explanation only and so as to not obscure the present disclosure with details that are well known to those skilled in the art. Nevertheless, the attached drawings are included to describe and explain illustrative examples of the present disclosure. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

Generally, the subject matter disclosed herein relates to electronic circuits and methods of operating the same, wherein a significant performance degradation of integrated circuits may be partially compensated for by appropriately increasing the supply voltage of the integrated circuit while nevertheless respecting upper limits of an allowable range of supply voltages and a corresponding thermal design power of the integrated circuit under consideration. Since the respective performance degradation, for instance in terms of maximum operating frequency, may be dynamically compensated for during the entire lifetime of the device, the respective guard bands used for specifying a certain performance class of a product may be significantly reduced, thereby providing the potential of assigning products to a specific performance segment, which conventionally would have been grouped into an inferior product segment. Consequently, the distribution of products in the high performance area may be grouped on the basis of less narrow tolerance ranges, thereby increasing the number of products that may be assigned to a specific high performance product segment. Thus, not only the profitability of a respective technology standard may be increased but also the overall performance of the products may be enhanced, since respective high performance integrated circuits may be operated with reduced performance loss over the entire lifetime without the necessity to artificially operate the devices at reduced operating speeds, as is the case for conventionally operated integrated circuits using the conventional approach with increased guard bands.

The principles disclosed herein may be applied in the context of advanced integrated circuits including circuit portions based on advanced CMOS techniques, such as microprocessors, advanced ASICs (application specific integrated circuits), storage devices and the like, since here significant advances with respect to reducing the overall product spread regarding performance characteristics typically involve great efforts in terms of the adaptation of manufacturing processes and circuit designs. However, the principles disclosed herein may also be applied to any integrated circuit devices in which a significant dependence of performance degradation or supply voltage is observed. Consequently, unless specifically set forth in the appended claims, the subject matter disclosed herein should not be considered as being restricted to any specific type of integrated circuits.

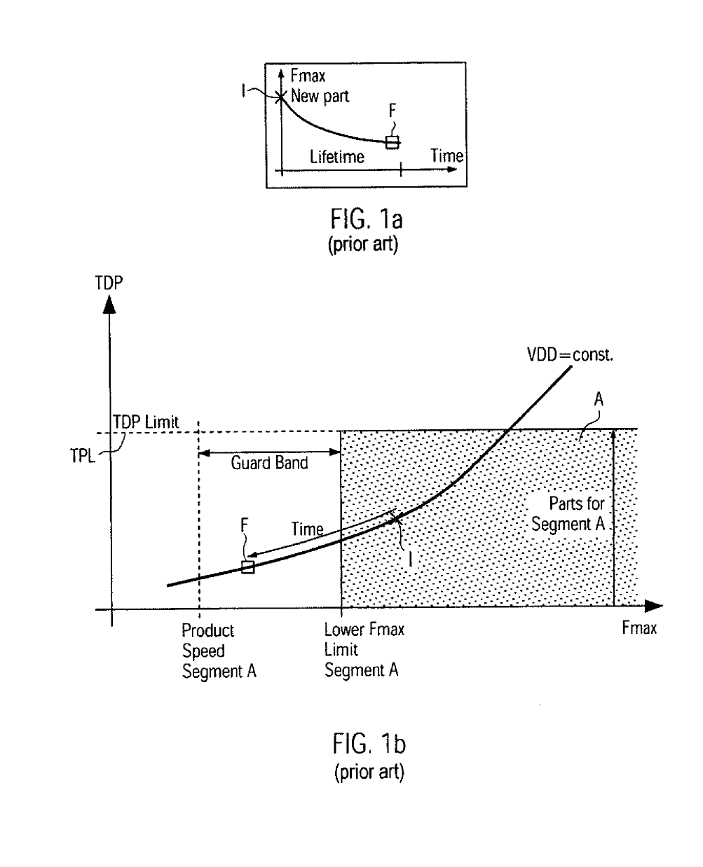

As previously discussed with respect to FIGS. 1a-1b, the maximum operation frequency in combination with a sufficient guard band determines the product segment a specific integrated circuit is classified to, wherein the guard bands are selected such that a performance degradation starting from initial performance characteristics is within the guard band even after the entire lifetime, for instance ten years for advanced microprocessors. Measurements carried out on standard integrated circuits using artificial aging techniques, i.e., techniques for accelerating the aging of the product under consideration, may demonstrate that, for instance, for microprocessors, the reduction in the maximum operating frequency corresponds to a shift along a corresponding progression, as previously explained. This shift of the operating characteristics with respect to maximum operating frequency and thermal design power may be attributed to the increase in threshold voltage of the respective field effect transistors, wherein the threshold voltage indicates the voltage at which a change of non-conductive to conductive state, and vice versa, of the transistor occurs. That is, a higher threshold voltage may reduce the inverse current and the drive current in the respective transistors for a given supply voltage, wherein, in particular, reduction of the drive currents is supposed to be a main cause for the performance degradation. According to the subject matter disclosed herein, it is contemplated that a controlled increase of the supply voltage may result in a significant reduction of the performance degradation, thereby providing an efficient means for stabilizing the behavior of the device over the entire lifetime thereof. Consequently, if required, the device may be operated at a higher operating speed over its entire lifetime compared to conventional devices, thereby enhancing the integrated performance of the device and of the respective application in which the integrated semiconductor device is employed.

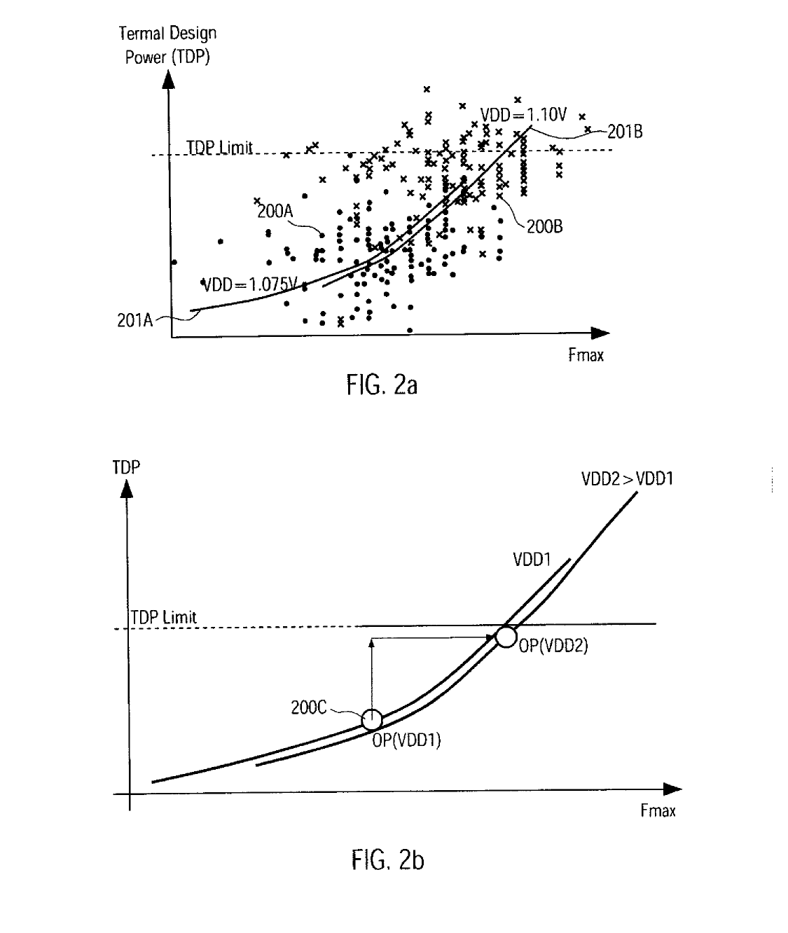

FIG. 2a schematically illustrates the evolution of the thermal design power (TDP) versus a performance parameter, such as the maximum operating frequency (Fmax) of microprocessors, for two different operating voltages (VDD). In FIG. 2a, the vertical axis represents the thermal design power, i.e., the thermal power that may be created within a respective integrated circuit when operated at its maximum frequency for a predefined thermal environment. Typically, an upper limit for the thermal design power is selected such that, for the given thermal environment, i.e., heat dissipation system and environmental conditions, an operation of the device under consideration may be guaranteed over the entire lifetime with a maximum operating frequency that is determined by the products speed segment, as previously explained. The horizontal axis of FIG. 2a represents the performance parameter, i.e., in the present case, the maximum frequency (Fmax) of the integrated circuits. The measurement points 200A may represent experimental data related to devices operated on the basis of a supply voltage of, for instance, 1.075 V, wherein the measurements data may be obtained during the entire lifetime of devices. It should be appreciated that the corresponding measurement points 200A may have been obtained during an accelerated test regime, as previously explained. Similarly, the measurement points 200B may represent integrated circuit devices of the same type, however operated at an increased supply voltage of, for instance, 1.10 V. The curves 201A and 201B represent the shift in performance (Fmax) and thermal design power of the respective integrated circuits represented by the measurement points 200A, 200B. As is evident from FIG. 2a, curve 201B may be considered as being displaced upwardly and to the right compared to curve 201A, thereby indicating that an increased supply voltage may result in higher performance, however, at the cost of increased thermal design power. However, FIG. 2a also indicates that the maximum operating frequency within the allowable range of the plot of FIG. 2a may be increased by increasing the supply voltage, thereby “shifting” the respective integrated circuit upwardly with respect to its performance characteristics, thereby concurrently enabling a compensation of the natural aging of the device.

FIG. 2b illustrates the situation of FIG. 2a in a simplified manner, wherein the shift in operating characteristics in a single integrated circuit, indicated as 200C, initially operated at a lower operating voltage (VDD1), to a different operating point corresponding to a second higher supply voltage (VDD2), is illustrated, while nevertheless maintaining the device 200C below the thermal design power limit. As is evident from FIG. 2b, the reduction in the performance parameter may be compensated for or even overcompensated for by applying an increased supply voltage as long as the device remains below the thermal design power limit and also respects an upper limit for the supply voltage. Consequently, by appropriately increasing the supply power over the operating time of the device under consideration, a performance degradation according to the general progression as explained with reference to FIGS. 1a, 1b and 2a may be compensated for, at least partially, thereby providing enhanced performance over the entire lifetime of the integrated circuit device.

In some illustrative embodiments, the respective supply voltage for an integrated circuit may be increased in appropriately selected incremental steps such that the degradation of performance may be compensated for or reduced while respecting the limits with respect to power consumption and maximum supply voltage. In other cases, the adaptation of the supply voltage with respect to the performance degradation may be performed in a substantially continuous manner, thereby providing substantially continuous operational behavior of the device. In some illustrative embodiments, the degradation in performance may be monitored over a certain time period within a preselected allowable range of performance degradation and a respective increase of supply voltage may be determined that may be required for compensating for the performance degradation. The required increase of supply voltage may be evaluated with respect to the available allowable supply voltage range in order to estimate appropriate incremental steps for increasing the supply voltage over the entire lifetime of the device in order to obtain a highly predictable compensation behavior and an expected magnitude of performance loss over the entire lifetime. In other illustrative embodiments, a maximum supply voltage may be applied that is compatible with the range of allowable supply voltages and maintains the device at the upper limit of the thermal design power. In this way, the actually obtained performance compensation may be highly correlated to the shift in thermal design power of the non-compensated device, as for instance shown in FIGS. 2a-2b, and may provide a substantially constant performance behavior as long as the supply voltage may be maintained within the allowable range.

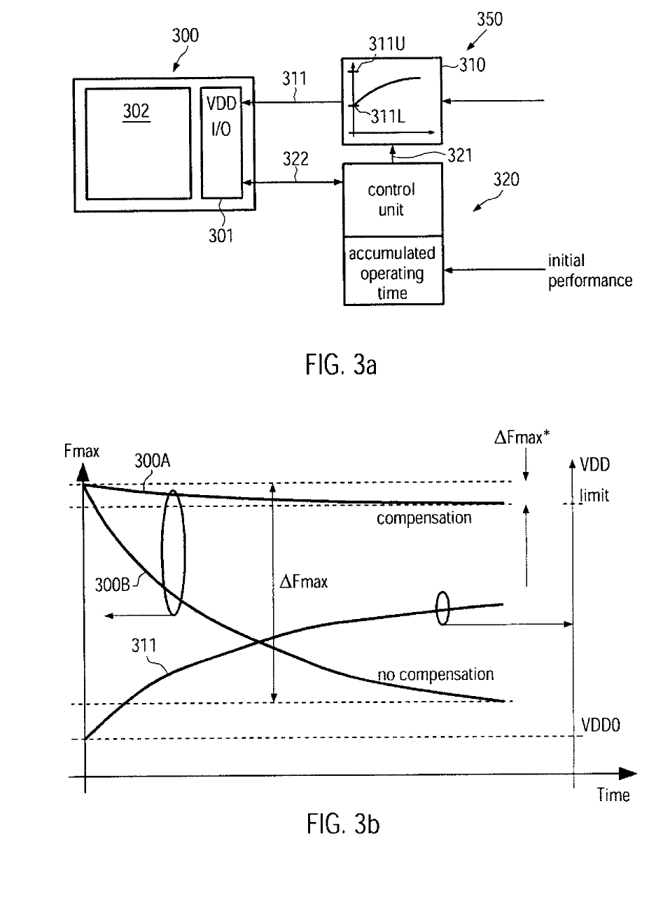

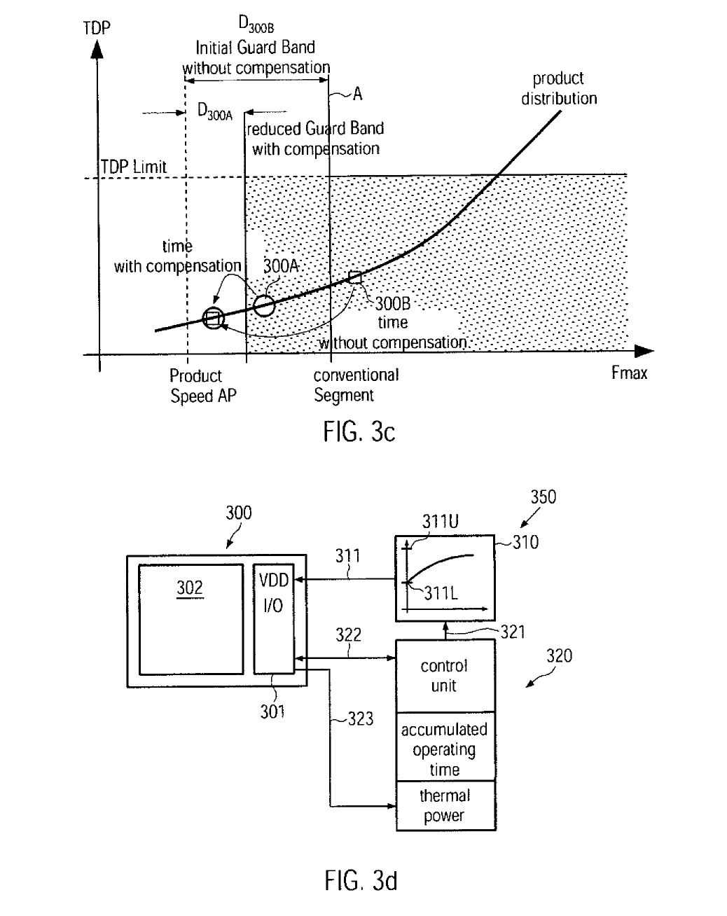

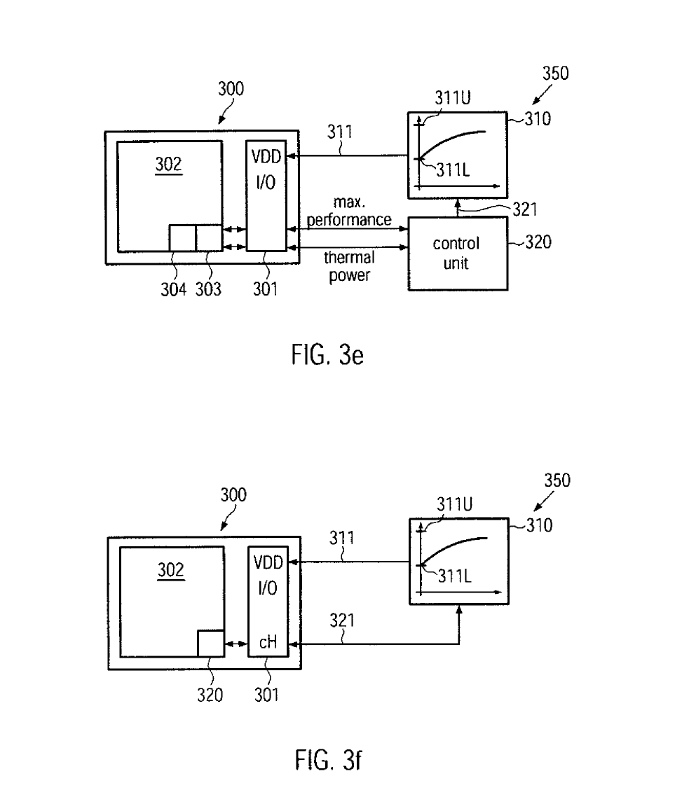

FIG. 3a schematically illustrates an electronic circuit 350 comprising an integrated circuit 300, a controllable supply voltage source 310 and a control unit 320 according to illustrative embodiments. The integrated circuit device 300 of the circuit 350 may represent any advanced semiconductor device, as previously explained. In some illustrative embodiments, the device 300 may represent an advanced CPU, which may comprise one or more device portions, such as CPU cores, memory areas, I/O (input/output) areas and the like. For instance, the integrated circuit 300 may comprise an I/O portion 301 that is configured to provide signals to peripheral devices (not shown) and to receive signals from other components, for instance, from the supply voltage source 310. The integrated circuit 300 may further comprise a circuit portion 302 including any functional blocks according to the desired circuit layout. The circuit portion 302 may communicate with the I/O portion 301 for exchanging signals, supply voltages and the like. It should be appreciated that the integrated circuit 300 may be formed on the basis of a common semiconductor material so that the I/O portion and the internal circuit portion 302 may be formed on the basis of a common manufacturing process for forming circuit elements, such as field effect transistors, capacitors, contact pads and the like. The integrated circuit 300 may be provided in a specific package (not shown) which provides heat dissipation capabilities, wherein a specified thermal power generated in the device 300 during operation may be dissipated via the package on the basis of appropriately defined environmental conditions. A thermal design power may be understood, for example, as the heat energy that may be created in the unit time according to the specified power consumption of the device.

The supply voltage source 310 may be provided in any appropriate form so as to enable a generation of a highly stable yet controllable supply voltage 311, wherein the voltage source 310 is, in particular, configured to provide the supply voltage 311 within an allowable range of supply voltages having a lower limit 311L and an upper limit 311U. It should be appreciated that the term “stable” in the context of the supply voltage 311 is to be understood such that the supply voltage 311 corresponds to a control signal 321 and maintains its value, except for device-specific variations of the voltage source 310, as long as the control signal 321 instructs the voltage source 311 to provide the same voltage level. It should further be appreciated that respective minute variations of the control signal 321 may also be included in the term “stable” supply voltage. The voltage source 310 may be comprised of any appropriate components, such as switched up and/or down converters, linear regulators and the like. In some illustrative embodiments, the voltage source 310 may be provided as an external component with respect to the integrated circuit 300, i.e., the circuit elements of the voltage source 310 may be formed in a separate carrier material or may be a separately operating voltage source unit, such as a semiconductor material, while, in other cases, one or more components of the voltage source 310 may be formed commonly with any circuit elements of the integrated circuit 300, thereby enhancing the overall manufacturing process. Respective circuit components, such as inductors, capacitors and the like, which may be difficult to be integrated into the device 300 may be provided as external components.

The control unit 320 may be configured to establish the control signal 321 so as to maintain the voltage 311 within a specified allowable range and also to maintain the thermal design power below the upper limit of the device 300, as previously explained with reference to FIGS. 2a-2b. In one illustrative embodiment, the control unit 320 may be configured to monitor or estimate the accumulated operating time of the integrated circuit 300 and to appropriately increase the supply voltage 311 by generating the control signal 321 on the basis of a value indicating the accumulated operating time of the device 300. For instance, a device-specific progression of performance degradation may be implemented in the control unit 320 in any appropriate form, from which the control unit 320 may derive an appropriate value for increasing the supply voltage. For instance, the control unit 320 may receive or may have received information with respect to the initial performance characteristics of the device 300, for instance the Fmax value corresponding to the state I (FIG. 1a), which may, as an example, indicate that the device is near its thermal design power limit when operated at its maximum operating speed. In this case, the control unit 320 may decide to initiate degradation compensation only after a predetermined interval of the accumulated operating time is elapsed so as to ensure that a corresponding increase of the supply voltage 311 after the specified interval may not result in exceeding the upper limit of the thermal design power.

In other illustrative examples, the control unit 320 may determine the power consumption for the device 300 on the basis of the supply voltage 311 with an additional current measurement (not shown) during an initial operating time of the device 300 for which it is ensured that the thermal design power is within its allowable range. For this purpose, the device 300 may have implemented therein an appropriate mechanism for causing the device 300 to operate at maximum performance within a specified time interval so as to enable a meaningful measurement of the power consumption, which may otherwise vary during normal operation according to the application-specific utilization of the electronic circuit 350.

The control unit 320 may be provided externally to the integrated circuit 300, as, for instance, shown in FIG. 3a, and may, in other illustrative embodiments, be integrated in the device 300, partially or completely, as will be described later on in more detail with reference to FIG. 3f.

FIG. 3b schematically illustrates the effects of operating the electronic circuit 350 according to the principles disclosed herein compared to a conventionally operated device. For instance, it may be assumed that two identical versions of the integrated circuit 300 may be operated with and without the control unit 320. During the operation of the circuit 350, the supply voltage 311 is supplied to the I/O portion 301, thereby causing the circuit portion 302 to operate in the desired manner. For example, an application program may run in the circuit portion 302 and the like. The voltage source 310 may provide the supply voltage 311 on the basis of the control signal 321, so that the control unit 320 may be aware of any power down and power up events for the integrated circuit 300. As previously explained, in some embodiments, the accumulated operating time may be determined or monitored by the unit 320 so as to decide whether or not an increase of the supply voltage 311 is to be initiated. For example, the available range of supply voltages may be divided in appropriate increments with respect to the entire lifetime of the integrated circuit 300 to provide a corresponding voltage increase when a corresponding section of the accumulated operating time has elapsed. As previously discussed, in some cases, the respective effect of an increase of the supply voltage 311 on the thermal power created by the device 300 when operated at maximum speed may be determined prior to or immediately after an actual increase by any appropriate technique. For instance, alternatively or additionally to the above-described strategy, the controller 320 may be connected with the integrated circuit 300 to exchange signals 322 with the device 300 in order to enable a reliable estimation of the thermal power associated with an increased supply voltage. For instance, the control unit 320 may cause the device 300 to operate at maximum performance so as to determine the power consumption of the device 300 for this operating condition. If the power consumption indicates the exceeding of the thermal design power, an increase of the supply voltage 311 may not be performed or the voltage increase initiated immediately prior to the measuring of the power consumption may be withdrawn and the device 300 may further be operated on the basis of the previous supply voltage.

FIG. 3b schematically depicts a graph for illustrating the operational behavior of the electronic circuit 350 when operated with the control unit 320, represented by curve 300A, and without the control unit 320, represented by curve 300B. The vertical axis on the left-hand side of FIG. 3b represents a performance parameter, such as the maximum frequency (Fmax), of a microprocessor, while the horizontal axis represents the operating time of the integrated circuit 300. In the conventional case, represented by curve 300B, a significant performance degradation may occur during the lifetime of the device, as previously explained and indicated by ΔFmax. On the other hand, when operating the electronic circuit 350 on the basis of the control unit 320, the supply voltage 311 may be appropriately increased over the operating time of the circuit 300, starting from initial supply voltage VDD0 as is indicated at the vertical axis on the right-hand side of FIG. 3b. Thus, over time, the supply voltage 311 is increased according to discrete steps (not shown in FIG. 3b) or in a substantially continuous manner, thereby reducing the degradation of the performance parameter, resulting in curve 300A. Consequently, a significantly reduced difference between the initial performance and the final performance, indicated as ΔFmax*, may be accomplished. Moreover, as is illustrated in FIG. 3b, the increase of the supply voltage 311 may be performed such that the voltage 311 is within the allowable range even at the end of the operating time of the device 300.

FIG. 3c schematically illustrates a graph similar to the illustration of FIG. 1b for an integrated circuit configured and operated according to the principles disclosed herein compared to a conventionally configured and operated integrated circuit. In FIG. 3c, the vertical axis represents the thermal design power (TDP), wherein the respective upper limit thereof is indicated by a horizontal line. A performance parameter, such as the maximum operating frequency, is represented by the horizontal axis, wherein the vertical line A represents the conventional speed segment in combination with a conventional guard band D_{300B} defined by the difference of the lower limit of the speed segment A and the desired product speed AP. That is, as previously explained, a conventional device 300B having an initial maximum operating speed in the vicinity of the conventional speed limit A will have a final performance behavior, for instance in maximum operating speed or maximum operating frequency, that is above the product speed limit AP, thereby rendering the device 300B as appropriate for a product corresponding to the product speed AP. However, any other conventional device positioned within the conventional guard band D_{300B} may not be allowed to represent a product appropriate for a product speed AP. On the other hand, the integrated circuit 300 configured and/or operated according to the principles disclosed herein may have an initial performance behavior corresponding to the position as indicated in FIG. 3c. That is, even if the initial maximum operating frequency of the device 300 is well within the conventional guard band, the performance degradation may be significantly reduced, despite the different data ΔFmax values for the curves 300A and 300B so that, at the end of the lifetime of the device 300, the maximum operating frequency is above the product speed AP, thereby enabling a significant reduction of the guard band, as indicated by D_{300A}. That is, according to the techniques disclosed herein, the number of integrated circuits 300 appropriate for the product speed AP may be significantly higher compared to conventional techniques in which any integrated circuit corresponding to the conventional guard band D_{300B} may have to be assigned to a lower product speed.

FIG. 3d schematically illustrates the electronic circuit 350 according to further illustrative embodiments. As shown, the control unit 320 may be configured to estimate the thermal power and thus the thermal design power of the integrated circuit 300 on the basis of a signal created within the device 300. For example, an internal temperature signal may be generated in the device 300 and may be provided as a measurement signal 323 to the control unit 320. For instance, the signal 323 may be provided as an analog signal or a digital signal and may indicate the temperature of a critical circuit portion of the device 300. Furthermore, based on other status signals, such as the signals 322, the control unit 320 may establish an estimation of the thermal design power, for instance, by monitoring the processing load of the device 300 in combination with relevant temperature information conveyed by the signal 323. In this way, a decrease of operating temperature may be monitored with respect to the maximum processing load, thereby enabling the detection of performance degradation, which may then be compensated for by appropriately increasing the supply voltage 311, as previously explained. In this manner, the respective increase of supply voltage over the lifetime of the device 300 may be performed in strong correlation with the actually created thermal power, thereby avoiding exceeding the thermal design power.

FIG. 3e schematically illustrates the electronic circuit 350 according to further illustrative embodiments. As shown, the integrated circuit 300 may comprise a dedicated test portion 303 that may be operated with maximum performance, for instance, by providing an appropriately designed oscillator or any other appropriate test circuitry. Furthermore, the dedicated test portion 303 may be coupled to a measurement portion 304 configured to estimate a thermal power created in the dedicated test portion 303. For instance, the portion 304 may comprise an appropriately designed diode for obtaining temperature-related signals and the like. The portions 303 and 304 may communicate with the control unit 320 via the I/O interface 301, wherein, in some illustrative embodiments, one or both of the portions 303 and 304 may be activated by the control 320 at any appropriate time. Consequently, during operation of the electronic circuit 350, the control unit 320 may obtain information with respect to the maximum performance and the related thermal power and may therefore select an appropriate increase of the supply voltage 311 in order to compensate for or even overcompensate for the natural performance degradation of conventional devices. For example, depending on the progression of the performance degradation, the range of allowable supply voltages may be utilized in its entirety, thereby providing the potential for providing enhanced stability of device performance or even for improving device performance. For instance, in FIG. 3b, the increase of the supply voltage 311 is well within the allowable range of supply voltages so that a further reduction of performance degradation may be achieved by applying higher supply voltages. A corresponding “prediction” for the future progression of the increase of supply voltage versus the actually obtained performance degradation may be obtained on the basis of the signals provided by the portions 303 and 304. For example, an extended period of “monitoring” may be used to obtain meaningful measurement results, which may allow obtaining a relevant prediction for the further development of the performance parameter. On the basis of the respective prediction, a highly efficient compensation strategy may then be applied for the remaining lifetime of the device, since the available range of supply voltages may be exploited more efficiently.

FIG. 3f schematically illustrates the electronic circuit 350 according to further illustrative embodiments, in which the control unit 320 may be integrated in the integrated circuit 300, i.e., the control unit 320 and the portions 302 and 301 may be formed on the basis of a common semiconductor material layer so that the same manufacturing techniques and processes may be applied to the portions 301 and 302 and the control unit 320. It should be appreciated that the control unit 320 may represent an integrated part of the portion 302 and may also be used for other purposes, such as processing user applications and the like. For example, the control unit 320 may be implemented in a microprocessor without significant hardware configurations, except for the capability of generating the control signal 321. In some illustrative embodiments, the control unit 320 may have incorporated therein one or more portions appropriate for detecting maximum performance parameter values, such as maximum operating frequency and a thermal power associated therewith, as previously explained with reference to FIG. 3e. Thus, also in this case, a significant dynamic adaptation of the performance characteristics may be obtained by appropriately increasing the supply voltage on the basis of the accumulated operating time while nevertheless providing a compact configuration of the circuit 350 without requiring significant changes in the overall design of the integrated circuit 300.

As a result, the subject matter disclosed herein provides devices and techniques that enable the stabilization of the performance behavior of an integrated circuit over its entire lifetime by appropriately increasing the supply voltage thereof while nevertheless respecting product-specific constraints, such as the thermal design power and the like. Consequently, the number of integrated circuits that may be used for a specified performance category may be significantly increased without requiring significant process adaptations and without any design changes. Due to the superior compensation of performance degradation over the lifetime of an integrated circuit, the respective guard bands for classifying the integrated circuits may be reduced, thereby providing the potential for obtaining higher prices for integrated circuits that may have conventionally been classified in less sophisticated categories, which may finally translate into higher profitability on the basis of the same manufacturing technology.

The particular embodiments disclosed above are illustrative only, as the invention may be modified and practiced in different but equivalent manners apparent to those skilled in the art having the benefit of the teachings herein. For example, the process steps set forth above may be performed in a different order. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed:

1. A method of stabilizing performance of an integrated circuit device, said method comprising:
determining a value of a first parameter indicating an accumulated operating time of said integrated circuit device; and
increasing a supply voltage to said integrated circuit device from a first voltage value to a second voltage value on the basis of said value of said first parameter.

2. The method of claim 1, further comprising determining a value of a second parameter indicating an estimated power consumption of said integrated circuit device at said second voltage value, wherein said increasing of the supply voltage is controlled on the basis of the value of said second parameter.

3. The method of claim 1, further comprising updating the value of said first parameter at least several times over a lifetime of said integrated circuit device and wherein said increasing of the supply voltage is controlled on the basis of the value of said first parameter after updating the value.

4. The method of claim 1, wherein determining the value of said first parameter comprises determining a speed parameter value representing a current operating speed of said integrated circuit device.

5. The method of claim 4, wherein determining said speed parameter value comprises measuring an operating speed of an internal circuit portion of said integrated circuit device at several times during the lifetime of said integrated circuit device.

6. The method of claim 1, wherein controlling said increasing of the supply voltage comprises generating an internal control signal and supplying said internal control signal to an external voltage source to initiate said increasing of the supply voltage.

7. The method of claim 1, wherein controlling said increasing of the supply voltage comprises generating a control signal externally to said integrated circuit device and supplying said control signal to a voltage source to initiate said increasing of the supply voltage.

8. The method of claim 1, further comprising comparing said second voltage value with an upper limit of an allowable supply voltage range of said integrated circuit device prior to actually using said second voltage value.

9. The method of claim 1, further comprising measuring a thermal parameter value representing a thermal power of said integrated circuit device and controlling said increasing of the supply voltage on the basis of said thermal power parameter value.

10. The method of claim 9, wherein measuring said thermal parameter value comprises generating an internal temperature signal in said integrated circuit device and using said internal temperature signal for controlling said increasing of the supply voltage.

11. The method of claim 9, wherein measuring said thermal parameter value comprises generating a temperature signal externally to said integrated circuit device and using said temperature signal for controlling said increasing of the supply voltage.

12. A method, comprising:
monitoring a maximum performance parameter value representing a current maximum operating performance of at least a portion of an integrated circuit device at a current nominal supply voltage;
monitoring a thermal power parameter value representing a thermal power generated in said integrated circuit device, said thermal power corresponding to said current maximum operating performance; and
increasing said nominal supply voltage for the further operation of said integrated circuit device when an updated maximum performance parameter value corresponding to said increased nominal supply voltage and an updated thermal parameter value corresponding to said increased nominal supply voltage each remain within a respective predetermined allowable range.

13. The method of claim 12, wherein said maximum performance parameter includes a maximum operating speed of at least said portion of said integrated circuit device.

14. The method of claim 12, wherein monitoring said maximum performance parameter value comprises determining an initial maximum performance parameter value, determining an accumulated operating time of said integrated circuit device and determining said increased nominal supply voltage on the basis of said initial maximum performance parameter value and said determined accumulated operating time.

15. The method of claim 12, wherein said nominal supply voltage is increased at least several times during the lifetime of said integrated circuit device so as to reduce degradation of the maximum performance over time.

16. The method of claim 12, wherein monitoring of said maximum performance parameter value is performed on the basis of an internal performance control signal.

17. The method of claim 12, wherein monitoring of said thermal power parameter value is performed on the basis of an internally generated temperature signal.

18. The method of claim 12, wherein monitoring said maximum performance parameter value comprises determining said maximum performance parameter value at regular time intervals during operation of said integrated circuit device.

19. The method of claim 12, wherein monitoring said maximum performance parameter value comprises determining said maximum performance parameter value at least once after each power-up event.

20. An electronic circuit, comprising:
an integrated circuit to be operated with a nominal supply voltage corresponding to maximum performance of said integrated circuit;
a controllable supply voltage source configured to provide said nominal supply voltage for said integrated circuit on the basis of a control signal; and
a control unit configured to establish said control signal so as to increase said nominal supply voltage with increasing accumulated operating time of said integrated circuit while maintaining said increased nominal supply voltage within a predetermined allowable range.

21. The electronic circuit of claim 20, wherein said control unit is further configured to estimate a maximum thermal power correlated with said increased nominal supply voltage and to establish said control signal on the basis of said estimated maximum thermal power.

22. The electronic circuit of claim 20, wherein said integrated circuit and said control unit are formed on a common semiconductor material.
